(19) United States
(12) Patent Application Publication
(10) Pub. No.: US 2023/0279697 A1
(43) Pub. Date: Sep. 7, 2023

(54) SAFETY LOCK WITH DOUBLE CLOSURE AND APPLICATION FOR USE

(71) Applicant: RODRIGO LOPES MOREIRA, SAO PAULO SP (BR)

(72) Inventor: RODRIGO LOPES MOREIRA, SAO PAULO SP (BR)

(21) Appl. No.: 18/007,075

(22) PCT Filed: Jul. 16, 2021
(86) PCT No.: PCT/BR2021/050303

§ 371 Date: Jan. 27, 2023

(30) Foreign Application Priority Data
Jul. 27, 2020 (BR) 1020200152700

(51) Int. Cl. E05B 47/02; E05B 47/06; E05B 77/44; E05B 83/02; E05C 9/04; E05B 47/00

(52) U.S. Cl. CPC E05B 47/026; E05B 47/06; E05B 77/44; E05B 83/02; E05C 9/04; E05B 47/0012

(57) ABSTRACT

The lock (1) includes a rear axis (1.3); the front (1.2) and rear axles (1.3) slide over the bearings (1.1.1) supported on base drawings (1.1); bearings (1.1.1) are welded to reinforcements (1.1.2); the lock (1) includes pins (1.1.3) welded to the base (1.1) of the lock (1); the pins (1.1.2); and (1.1.3) include racks (1.2.4) and (1.3.4), and oblong openings (1.2.5) and (1.3.5), with each oblong opening running on one of the pins (1.1.3); the gear (1.4.4) is engaged to the racks (1.2.4) and (1.3.4); the front (1.2) and rear axles (1.3) define a double closure applied by the lock (1) which comprises limit stop switches attached to the steel plate (1.8.1) that is fixed to the base (1.1); the limit stop switches (1.8) and (1.9) are attached to the base (1.1) indicating the axles position to the activation peripherals.

### FIELD OF APPLICATION

This Invention patent application refers to a safety lock for doors in general, which may be used in property security, in access control doors, as well as in the automotive branch, or even used in freight carrier doors, van and utility vehicles, containers, etc. being applied in this case to the cargo compartment of said vehicles. The object proposed by this Invention patent application comprises safety equipment in general.

### INTRODUCTION

This specification refers to the Invention patent application of a new model of safety lock designed to work in combination with smart opening systems, in order to ensure safety against undue violation, in addition to full access control and recording of all actions.

### STATE OF THE ART

As is common knowledge, land-based cargo transports have been increasingly harassed by robberies, and constant evolution is required from companies to provide additional safety measures against this criminal modality.

The state of the art comprises safety locks with different characteristics from the object of this Invention patent application, which will be commented in detail below.

As a technology approach that comprises the state of the art, the patent entitled “DISPOSIçÃO CONSTRUTIVA EM TRAVA DE SEGURANçA COM ABERTURA E LOCALIZAçÃO REMOTA [CONSTRUCTIVE ARRANGEMENT IN SAFETY LOCK WITH REMOTE POSITIONING AND OPENING]”-MU 8601581-8 may be cited, which includes the object described as follows “The lock that is object of this Utility Model patent application comprises a base, on which a relay module, a tracker module, front and rear contact keys and an electric engine are assembled, of which its gear is coupled to the pipe rack attached to an axis that moves a pair of bearings which are also assembled on the same base, one on the front and one on the back. All parts assembled on the base are protected by a cover that is also fixed to the same base”.

Another lock model also described in the state of the art is that addressed in the patent titled “TRAVA MOTORIZADA [MOTORIZED LOCK]”—BR 102016006498-8″, which provides that “The motorized lock of the Invention patent application comprises a structure manufactured in cast metal, housing parts that include, among others, an electric engine with an axis equipped with a gear that operates over a rack, at the end of which a locking pin is provided. The electronic circuit board that commands the operation of the electric engine is mounted under the electric engine, in addition to other components that include sensors. A cover is attached to the metal body in order to ensure full protection of the internal lock components, said cover being fastened using a screw.”

The lock described in patent BR 102018010325-3 may also be mentioned, which proposes a “SISTEMA DE TRAVA PARA BAÚ DE CARGA E CONTROLE DE ACESSOS [LOCKING SYSTEM FOR CARGO BOX AND ACCESS CONTROL], which provides that “This invention describes a Motor Box Lock with a mechanical system for movement of the rotating screw axis, attached by high resistance bearings and supported by a set of self-lubricating packing sleeves”.

### Problems with the State of the Art

The locks belonging to the state of the art have some aspects that could be improved, which are listed below:

The existing locks are locked with a single axis, making its application fragile for doors in general, particularly truck cargo box doors which are usually manufactured in aluminum and have no sturdy structure. In this case, the single locking mechanism facilitates forcible entry.

Another key aspect that could be improved and that characterizes the locks included in the state of the art is in the fact that the locks have no redundancy opening mechanism in case of electrical faults, and must be broken if failed and cannot be opened through electronic activation means.

Another relevant fact that may be mentioned as possible improvement regarding standard locks is the impossibility of opening the lock of the cables are cut, considering that existing locks within the state of the art require constant feeding and have no built-in wireless electronics for activation. Therefore, in such cases, namely cable cutting, these must be reconnected, which is sometimes difficult to diagnose and required many hours of maintenance, during which the vehicle remains unavailable. A potential conundrum is also when this occurs with cargo inside the box, causing great inconvenience for unloading and delays in delivery.

It should also be noted that the locks belonging to the state of the art have no dedicated hardware and software for lock function mechanism analysis and possible diagnostics of anomalies in functioning. In other words, the existing locks usually only undergo corrective maintenance, leading to inconveniences in case of any issue that prevents opening, leading to damages and lost time,

Another key aspect that may be improved regarding the locks included in the state of the art lies in the fact that their installation is performed using common screws and the lack of a dedicated hardware, such as an accelerometer, for identification when the lock is detached from the original locking position and repositioned in an inverse position regarding the locking placement, in other words, the lock is dislodged clockwise or counter-clockwise so that the locking pin is “air locking”, not fitted in the correct locking place that is originally on the bottom of the box and not setting off any misplacement alarms, therefore, not leading to any incidents and undue opening, facilitating robberies and leading to huge losses.

Another aspect that may be improved regarding locks from the state of the art is the fact that they can only be opened by a vehicle tracker when used in cargo box trucks. In that case, large fleet operators would face a major issue when owning large trucks that need to connect to tractors to operate with cargo transport. All tractors must have the same type of tracker of a single provider that the locks installed in the trucks may work normally, considering that they function with built-in electronics set to operate with a specific tracker type, and tractors or other kinds of third parties or aggregate vehicles from another brand or tracker type cannot be connected, which restricts operation or increases costs, as in some cases the truck owner has more than one lock installed to work with more than one tracker type/manufacturer, increase operation costs.

Another detrimental fact verified in the locks from the state of the art lies in the possibility of violation of the magnetic sensor installed in combination with the lock to identify the door opening and closure. This is due to the fact the sensor is a reed switch sensor, which uses a simple magnet and a tape, it is possible to be tampered as it has no pair identification. For this reason, when a breach is performed using another magnet and a tape that is generally used to glue the new magnet to the sensor, it creates an error information condition, where the status is seen as “door closed”, when, in fact, it is still open and was breached, through a very common practice in the market, facilitating violation and subsequent cargo theft.

Another issue found on the locks in the state of the art is that activation is performed through a tracker device that is usually installed in the vehicle dashboard. In view of that, specialized criminal gangs that act based on inside information are able to locate the tracker installation location and open the lock through the correct connecting wires using specific opening modules for this end.

Another major inconvenience of the locks from the state of the art is that they are only operated through trackers that mostly operate with GPRS communication systems. Therefore, there are some “blind spots” (where GPRS signals are weak or non-existent) where opening cannot be performed, and often the vehicle has to be moved to an area with sufficient GPRS coverage in order to open the lock, and only then proceed to the correct location for cargo unloading, which poses serious security risks.

### OBJECTIVES OF THE INVENTION

This Invention patent aims to provide a SAFETY LOCK WITH DOUBLE CLOSURE AND APPLICATION FOR USE which provides an increased security level due to:
a) having two locking axles, thus providing greater security against break-in.
b) integrating with application for use containing several security validations.
c) gathering all security items inside the cover, preventing breaches by third parties.
d) including internal real-time temperature sensors and gauges.
e) avoiding displacement from original locking position with the inclusion of internal accelerometer which will trigger a breach alarm in case of undue movement of the lock.
f) including built-in electronic redundancy key for main hardware or application failure.
g) including an internal module with the technologies Bluetooth, Wi-fi, GPS, Chip LORAWAn, SigFOX, RF (Radio Frequency) communication module and Zigbee communication module with owned network that allows integration with other wireless peripherals.
h) allowing breach identification when the locking pin does not reach both function statuses (“open”|“closed”).
i) allowing monitoring of engine operation for detection of possible anomalies and allocation for preventive maintenance.
j) including hardware that integrates with the encrypted door sensor with unique ID, preventing breach as in the reed switch and magnet sensor models.
k) having architecture which, according to the installation of the internal module on the lock, only allows breach if the door is forcibly open, as the entire assembly is protected inside the lock.

Another objective of the Invention patent lies in proposing a SAFETY LOCK WITH DOUBLE CLOSURE AND APPLICATION FOR USE, which also innovates regarding its portability characteristic for:
a) with the use of special tools and customized screws, allowing safe and quick installation and removal.
b) due to its portability, allowing the reasonable use only when the vehicle and cargo require its usage.
c) allowing installation in most door models around the world, as it works with an app and does not depend on a physical connection to operate (only needs power).
D) being able to be used as an internal electronic seal in containers, used throughout the cargo transport, and only being opened at the pre-established destination in any part of the world.
e) being able to be installed with installation kits developed according to the model and type of port by facilitating usage and fast replacement of the assembly.

Yet another objective of this Invention patent application proposes a SAFETY LOCK WITH DOUBLE CLOSURE AND APPLICATION FOR USE, which innovates in operation by:
a) facilitating daily use by the user, provided that all opening points and validations are configured in the webservice before the start of the operations.
b) immediate opening on all predefined opening points.
c) having the possibility of integration with the logistics area, allowing use in a single app to perform deliveries, remarks, in addition to all safety and control of doors and locks.
d) having no need of vehicle tracker for operation.

Yet another objective of this Invention patent is a SAFETY LOCK WITH DOUBLE CLOSURE AND APPLICATION FOR USE, in which:
a) Integration with other peripherals is provided and possible, such as alarm sirens, wireless blockers, numerical keyboards, among others.
b) It has backup battery inside the lock, avoiding breaches and system disconnection, generating evidence of tampering for main power cut-off situations, and may also be associated to an external solar charger.
c) it allows integration of the lock with wi-fi cameras for event recording.
D) it allows integration with other safety devices installed in the vehicle or the environment, such as another safety lock, fifth wheel lock and/or electronic vault, through wireless communication.

### BRIEF DESCRIPTION OF THE INVENTION

In addition to all aforementioned points, the safety lock with double closure, object of this Invention patent, has opening redundancies which differentiate them from other locks/door locks already known in the state of the art.

The first refers to the registration of opening points, the application already stores the valid delivery points and enables immediate opening via a button on the smartphone screen. If the point has not been recorded correctly, in other words, requiring the lock to be opened at a new point, the “hardware+software” set allows the generation of a random password directly on the smartphone screen which must be sent to a monitoring center. With this password in hand, the monitoring center operator types the password in a specific menu (Password and Counter-password Opening) which is cloud-based and runs 100% online. The user must then inform the request, and, on the same screen, validation of which user is really using the counter-password, vehicle, longitude and latitude, and date and time are performed, and the counter-password is generated after all validations and visualization on the map on the webservice screen indicating the location where the lock will be opened. However, the client may define the main form of opening, either by automatic validation or by password and counter-password.

The use mode for automatic opening in predetermined locations is translated into logistic gains for the client, since there is no need for many operators at the security center to generate and manage users and counter-passwords. The opening time may be shortened, gaining more time in the operation where there are many opening points, and reduces the approach risk, because the time at each stop is reduced.

Another form of redundancy may be obtained with the installation of a tracker in the inner part of the lock, already included in the patent MU-8601581-8 which already provided the use of this type of device inside a safety lock, which may send an opening command through the webservice in menu “Open by Tracker”.

The third and last one, but not less important, consists in an internal module in the safety lock with double closure that is object of this Invention patent, which is installed inside the lock and is completely detached from the Bluetooth/Wi-Fi module, and is also detached from the lock feed line, in other words, feeding comes from another external means, herein named external security opening key with RS485 communication protocol. This key is connected to the set through a four-wire outlet with an automobile plug included in the external harness of the lock which is always off and disconnected. This connection shall remain in a strategic location defined at the time of installation with the client, and poses no risk even if found out, since it does not function by pulse or retention of positive or negative logical signal, but with an encrypted protocol that functions with RS485 communication with due security established. This key includes, in addition to the RS485 chip, a battery that feeds both the electronic circuit and the internal redundancy board inside the lock, in other words, the internal redundancy electronic components with only two internal cables connected to the lock engine for activation, and will only be activated with the use of the external security opening key, remaining inert during the entire period regarding the occurrences of day-to-day operations, such as voltage surges, used only for cases in which the opening modes already featured above are not effective on opening the lock. The safety opening key also includes an internal GPS and a Bluetooth/Wi-Fi communication module. This serves to ensure safety for the operation, provided that the key, before use, must be configured in the webservice platform of the Applicant and all security information and rules required for the security opening key must be transmitted, thus defining the user, place of use, date and time as the key use interval, allowing the lock to be opened only on predefined locations and time intervals ensuring safety, so that if the key is lost, its usage is not allowed, and only our configuration platform is able to open it.

All the topics and redundancy opening forms listed above distinguish the safety lock with double closure, which is object of this Invention patent application, from other locks and door locks known in the state of the art, thus enabling a more efficient use, with no need for forced entry, cutting door frames or hinges that currently occur when the locks/door locks in the market fail to open. This greatly increases operational gains and significantly decreases the downtime for vehicle maintenance, lock replacement or lost time in deliveries due to failure in lock opening at the end customers.

In addition to all aforementioned benefits and included in the lock that is object of this Invention patent, there is also the fact that the entire activation control setup of the lock is located inside it, in other words, its access only occurs via wireless communication, except for the security opening key. This setup is placed inside the cargo compartment. Differently than what happens currently in the state of the art, when the criminals or specialized technicians already know where trackers are installed, usually on the vehicle dashboard, access the wires quickly and open the lock through the specific command wire. Now, for the lock referred to in this Invention patent, fir this to happen, the door must be breached in order to access the lock and all equipment inside it. That creates another layer of difficulty to breach the assembly, thus ensuring a higher level of security and risk reduction to all clients.

The aforementioned safety lock with double closure, object of this Invention patent, also comprises an optional internal or external backup battery that functions as a floating circle to recharge batteries. This allows the detection of undue power cuts, allowing the assembly to remain functioning. As optional features, there is the addition of a Bluetooth/Wi-Fi module from a GPRS model with data package chip, Chip LoraWan, Chip SigFox, RF (Radio Frequency) communication module, Zigbee communication module and other wireless communication means, to enable proper notification of abnormalities and breaches in the lock even when not connected to the smartphone. All these modules and electronic chips are placed inside the safety lock with double closure, object of this Invention patent application, thus preventing any possible electronic or electric break-in.

There is also the possibility of integration of a keyboard that must be allocated to the outer part of the door which may be configured for lock opening, mainly in situations of application of the lock on access doors, with its password being configured through the webservice and transmitted directly to the Bluetooth/Wi-Fi module. This password may be configured for each user and changed when needed. For applications on cargo compartment doors, its use is optional and also considered as redundancy opening to the aforementioned means; this application only requires placement of the keypad inside a protective case against water, dust and other external agents that may affect its operation.

The entire lock assembly object of this Invention patent functions on voltages between 10/32 VDC when applied to vehicles and 110/220 VAC, when applied on access doors. All circuits include specifications and protections relevant to this application. It functions between temperatures ranging from −40° to +85° C., granting the lock a wide range of locations and application types, with special mention to cold chamber trucks, where, as aforementioned, the internal cold chamber temperature may be measured with up to 8 sensors and the temperature is measured individually in each sensor, sent to the Bluetooth/Wi-Fi module through the OneWire network incorporated to the hardware, allowing for constant monitoring and information forwarding to the application for use and information viewing on the webservice, triggering alarms when the temperatures reach values differently from the specified values, values recorded for said transport which varies according to the type of cargo to be transported (cold or frozen products), thus helping the freight companies and cold cargo freighters to guarantee the correct temperature from start to end, maintaining the quality of the transported product.

Said lock, object of this Invention patent, also allows connection of the Bluetooth/Wi-Fi module and peripherals with Wi-Fi technology. This is possible because the main module object of this Invention patent becomes the primary Wi-Fi network with the other secondary items, to be paired by SSID and password to the main module, and may be monitored and receive commands from the main module with no need for wired connection. This enables infinite integrations, from other locks with Wi-Fi technology and module in the same vehicle, even alarm sirens, wireless fuel blocking modules, wi-fi camera for event recording after opening a door, for example, and other sensors and peripherals with wi-fi technology.

The lock also includes the lock connection with the encrypted sensor in its hardware. This sensor consists in a set of four wires, with two for feeding the reader circuit and two communication wires with the Bluetooth/Wi-Fi module (TX/RX). This sensor reads its pair installed at the other door leaf with a unique number, and this reading cannot be tampered with, or the sensor replaced without a new system setup and pairing, providing full security and preventing any breach attempts, such as occurs with magnets and reed switch type magnetic sensors. This encrypted sensor is also an object of this Invention patent.

The safety lock with double closure, object of this Invention patent application, comprises a base on which a Bluetooth/Wi-Fi electronic module with a (magnetic) hall sensor is assembled, an optional tracker module, front and rear contact keys for the tracker, and an electric engine with its gear coupled to two racks which, in turn, are attached to two axles that move through a front bearing assembled on the base, and a support with a rear pin for axis guidance, which are part of the base itself. All parts assembled on the base are protected by a cover that is also fastened to said base.

The safety lock with double closure, object of this Invention patent application, is also assembled on a reinforcement base, where it is fastened by customized safety screws, through the lid and is connected to variable measurement axles through a special nut and guided by bearings fastened to the structure and protected by a gutter.

### DESCRIPTION OF THE DRAWINGS

The lock, object of this Invention patent application, may be entirely known regarding construction, function and advantages by the detailed description to be done based on the attached drawings, in which:

FIG. 1 shows a top view with sectioned details of the lock with all items referring to the Bluetooth/Wi-Fi opening model with a cross section of the cover;

FIG. 2 shows a top view of the lock with all items referring to the Bluetooth/Wi-Fi opening model and internal tracker, without cover;

FIG. 3 shows a top view with section details only with the main items for mechanical functioning;

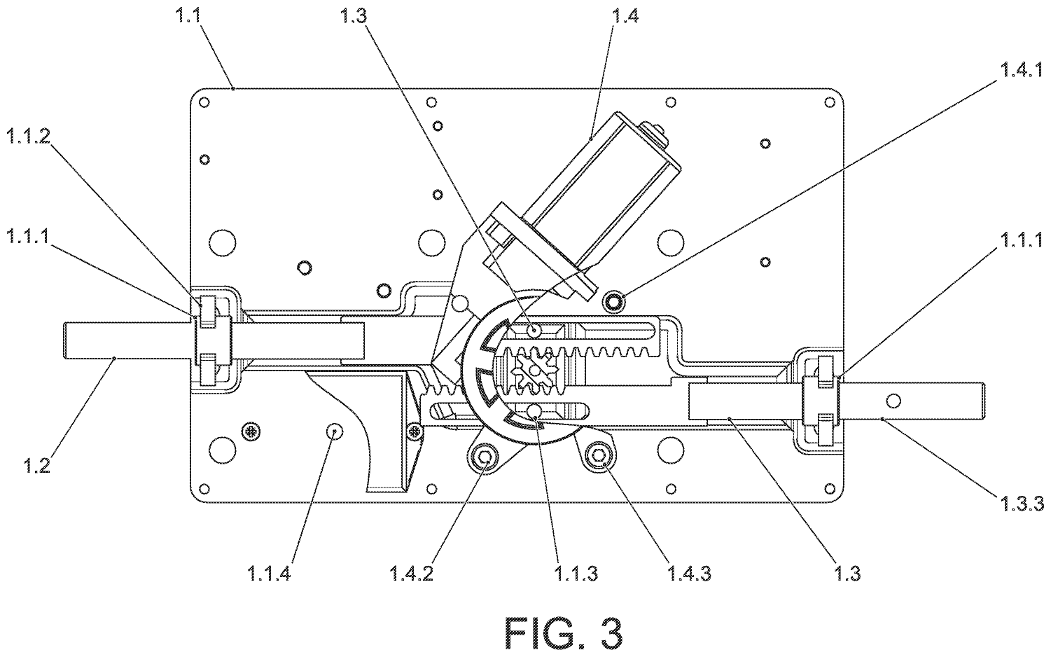

FIG. 4 shows an exploded view including all components of the lock in their respective positions;

FIG. 5 shows the electrical schematic of the lock with magnetic sensor;

FIG. 6 shows the electrical schematic of the lock encrypted sensor;

FIG. 7 shows a lower view of the lock, without the base, for demonstration of the engaged engine axis on the axles' racks;

FIG. 8 shows a front view with the lock activation assembly with extension axles without the protection gutter;

FIG. 9 shows a detailed view of FIG. 8 indicating the special safety screw, detail as indicated by the “X” symbol of FIG. 8;

FIG. 10 shows a front sectional view of the assembly of one of the extending axles near the yoke nut to one of the lock axles, sectional view the is taken from FIG. 8 such as indicated by section line “A”-“A”;

FIG. 11 shows a side view of an open cargo compartment door of a truck with the lock installed for proper application purposes, with the aforementioned truck being shown in a sectional lengthwise view;

FIG. 12 shows a side view of an open cargo compartment door of a container with the lock installed for proper application purposes, with the aforementioned truck being shown in a sectional lengthwise view;

FIG. 13 shows a front sectional view of a closed door of a cargo compartment of a van with the lock installed for due application purposes;

FIG. 14 shows a detailed view of FIG. 13 for illustration of the encrypted sensor, as indicated by the “Y” symbol of FIG. 13;

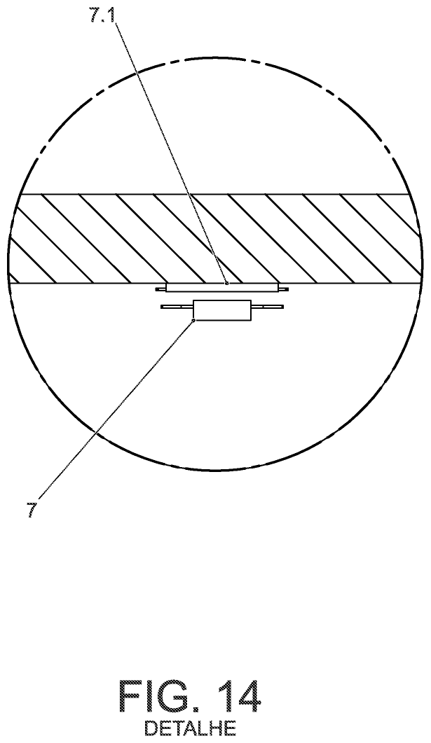

FIG. 15 shows a visual representation of the application and its connections;

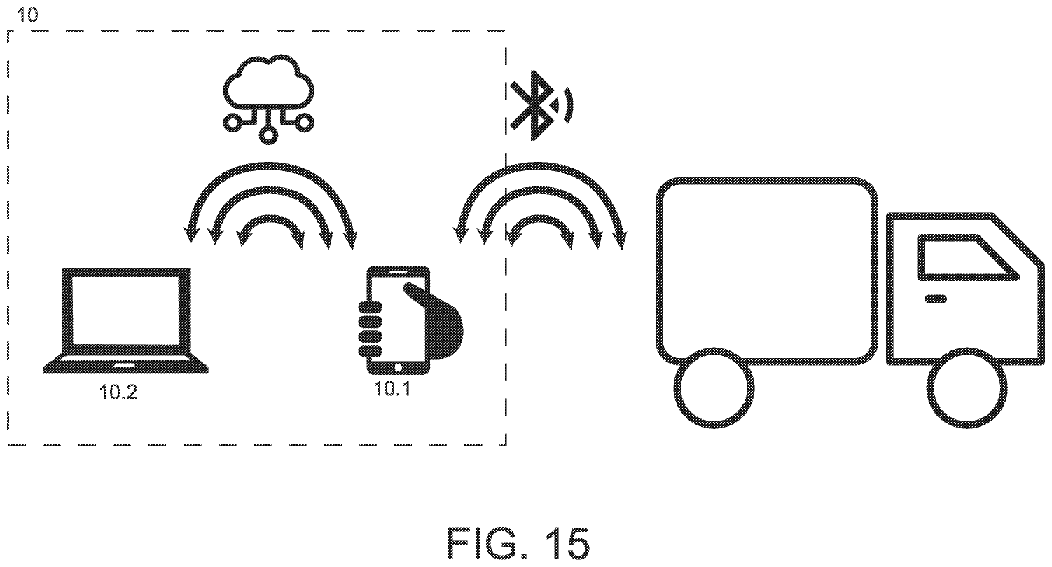

FIG. 16 shows a visual representation of the connection function of the application with the lock applied to access doors;

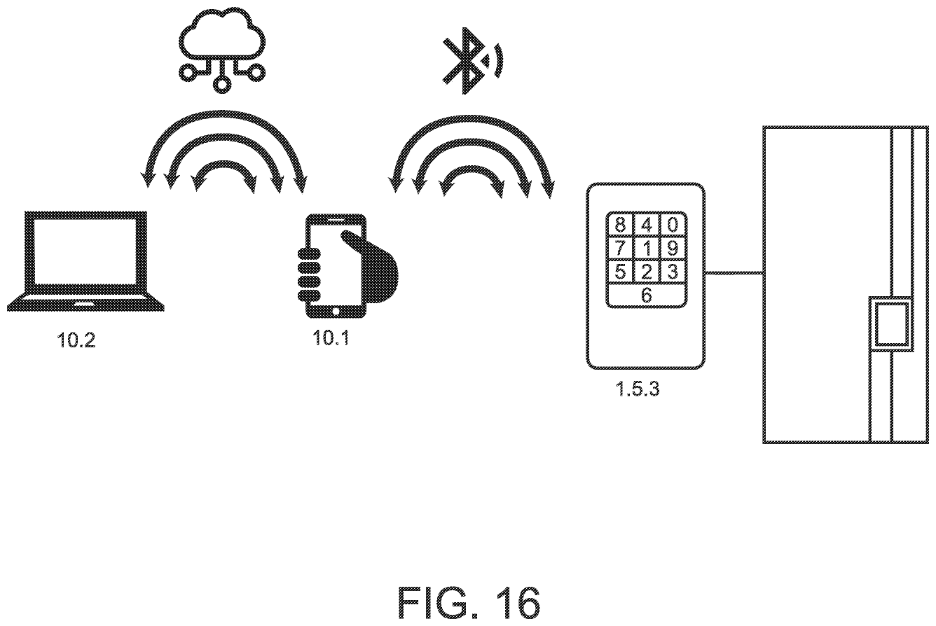

FIG. 17 shows a visual representation of the application with a keypad in redundancy in vehicle application;

FIG. 18 shows a visual representation of the application with a keypad in redundancy in vehicle application;

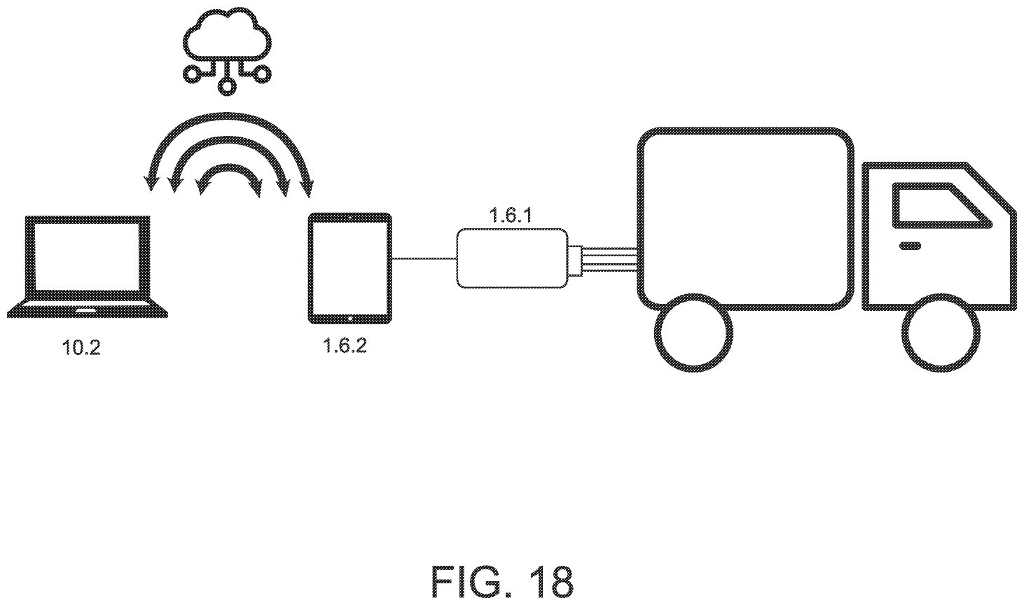

FIG. 19 shows a lower view exclusively from the cover of the main lock assembly;

FIG. 20 shows a detailed sectional view of the Bluetooth/Wi-Fi module and the RS485 module;

FIG. 21 shows a visual representation of the lock connection and other peripherals;

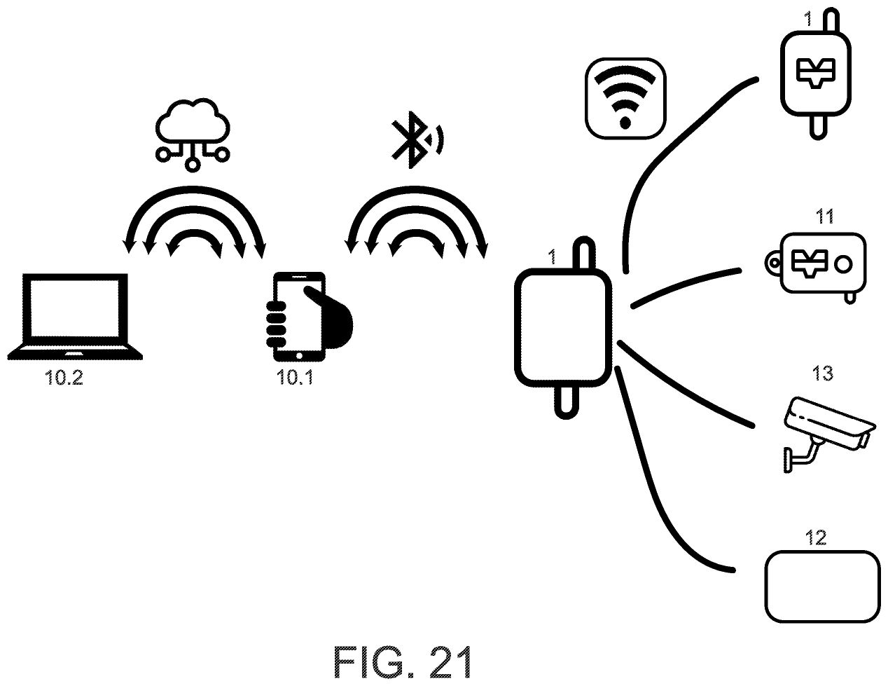

FIG. 22 shows an isometric view of the encrypted sensor with the identification tag;

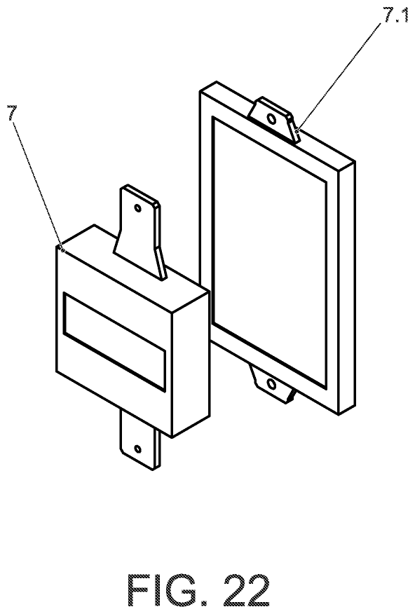

FIG. 23 shows an isometric view of the customized safety screw;

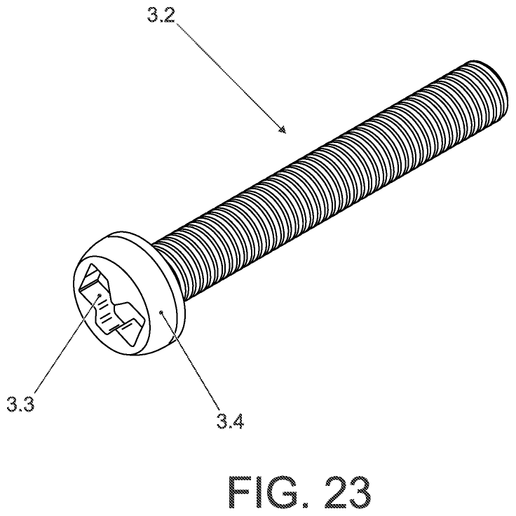

FIGS. 24A, 24B and 24C show orthogonal views of the customized safety screw; and

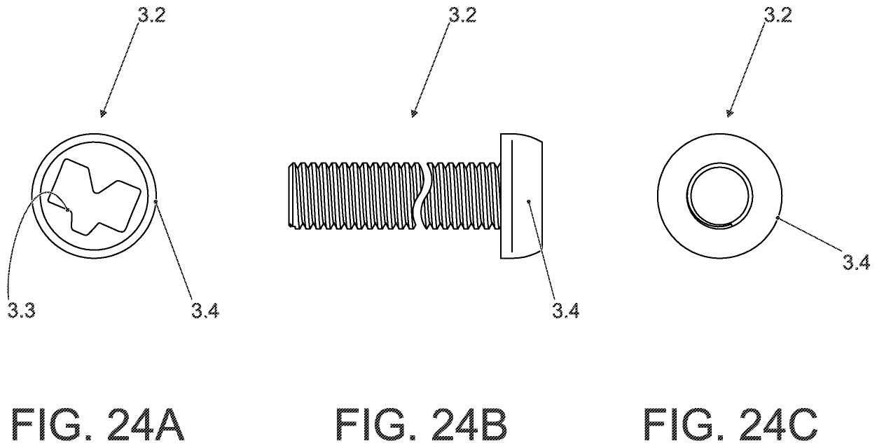

FIG. 25 shows an isometric view of the special tool developed for use in the customized safety screw.

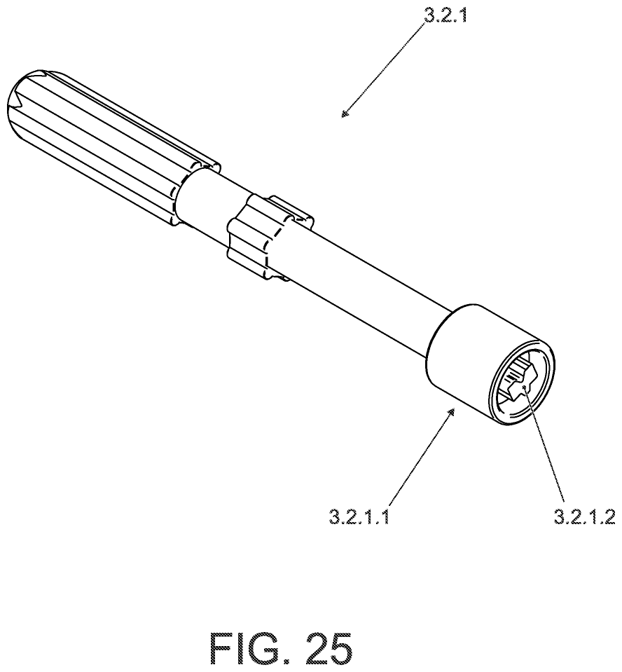

### DETAILED DESCRIPTION OF THE INVENTION

The safety lock with double closure, object of this Invention patent application, has several characteristics that distinguish it from other locks/door locks from the state of the art.

As an outstanding feature, the increase in security levels provided by the safety lock with double closure that is object of this patent provides is highlighted, considering that its locking method consists in two linear locking axles, opposite to each other so that, when installed on a door either for access control or on a vehicle cargo compartment, the door is locked in two opposite points, increasing the difficulty of breaching and subsequently the degree of security when compared to other locks in the market.

Another outstanding feature is related to the possibility for portability, considering that the lock that is object of this Invention patent has easy installation and removal as its technical differential, provided the special tool 3.2.1 is used, equipped with a coupling mouthpiece 3.2.1.1 with an internal protrusion 3.2.1.2 compatible with the cavity 3.3 provided on the head 3.4 of the screw 3.2 to release the front safety screws 3.2 with customized heads 3.4.

This feature is widely used in cargo box, vans and container doors, considering that in such cases, this portability is required and the use of a lock only for cases in which the vehicle/container holds cargo that the client and “lock/door lock owner” needs a more effective control and increased protection of the cargo. For this purpose, the installation of the full lock kit is required (this kit is manufactured for each application type, comprising the lock, the yoke nut and the customized safety screws, components included in all kits equally) which will be permanently attached to the door. This kit has low cost and, when installed, shall enable the portability of the lock, requiring only the connection of the nuts present at the end of each lock axis, the bars already included and attached to the door, in addition to the fastening of the lock using the special headed screws and automotive-type power feed connection plug already installed and positioned beside the lock fastening location, in other words, if the lock installation kit is already being used on the vehicle door, the only thing needed for installing and detaching the safety lock with double closure that is object of this Invention patent is connecting and disconnecting the front screws, the interconnection nuts of the lock axis to the locking and feeding axles, which are all included and installed on the door. This leads to logistic and financial gains, considering the locks will be used in vehicles/doors needed according to the cargo transported and do not require any specialized professional for replacement and installation, with no scheduled dates or vehicle displacement, and may be carried out by the client's staff itself (“lock owner”).

Another major highlight is in the operational aspect, considering that this safety lock with double closure, object of this Invention patent application, does not exclusively require trackers for operation, as with the other locks already known and belonging to the state of the art. This model includes an internal module for Bluetooth/Wi-Fi communication as its distinguishing feature, enabling lock activation through a smartphone application developed by the Applicant which, in combination with the aforementioned Bluetooth/Wi-Fi module, controls all actions of the lock and other sensors, mainly lock opening and closing through the smartphone with encrypted commands, open and closed door status, locked and unlocked pin status, door violation status, pin not reached end of course status, monitoring of engine running current for detection of possible wear and allocation for preventive maintenance, internal box temperature status through the OneWire network, accelerometer for identification of installation position and possible breach, guaranteed opening only in valid pre-recorded points, predefined door opening time control as safety rule with alarm generation when breached, showing as a warning: “Door opening time exceeded”, “Encrypted” door opening and closing sensor with factory configuration and registration, preventing breaches using magnets and other materials as occurs in models widely used in the market (reed switch type magnetic sensor), therefore a “lock closure failure” is able to set off an alarm if it fails to reach the end of its locking course, control of door opening and vehicles per pre-recorded user on the cloud-based webservice, in other words, a series of validations and safety information required that are not included in the locks/door locks already known in the state of the art.

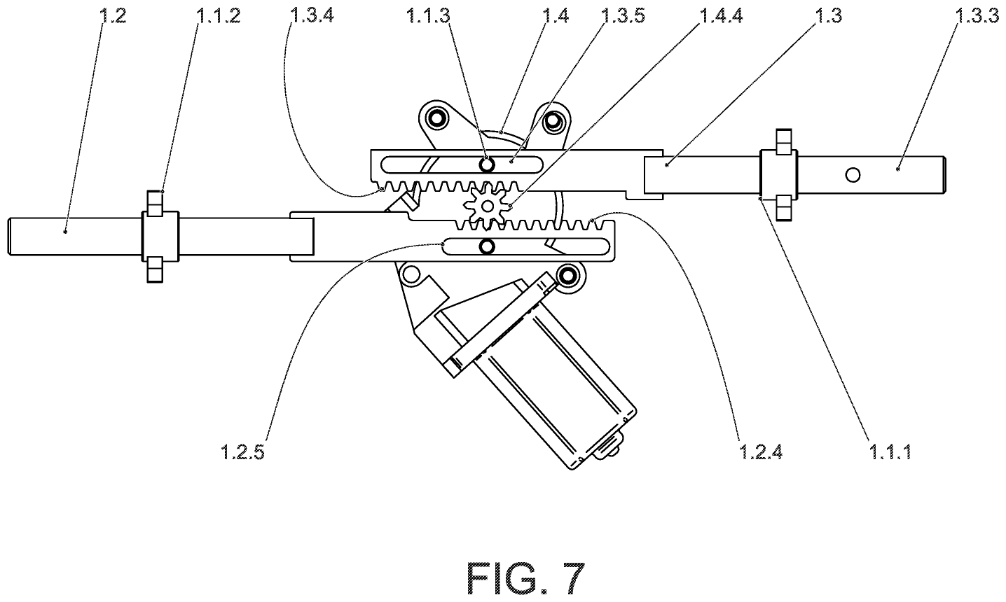

In reference to figures previously listed, the lock that is object if this Invention patent application, it is observed that in FIG. 7 the detail of the gear 1.4.4 of engine 1.4 which engages the rack 1.2.4 of the front axis 1.2, which follows patent MU 8601581-8, also fits the rack 1.3.4 to the rear part 1.3, different than the previous patent for being single axis, to perform the locking and unlocking movement of the front 1.2 and rear axles 1.3.

It is observed that both the front axis 1.2 and the rear axis 1.3 slide inside a bearing 1.1.1 and are supported on base recesses 1.1 and run through respective pins 1.1.3 which are lodged in respective oblong openings 1.2.5 and 1.3.5 which serve both as guides for alignment and for preventing extra movement from said axles in relation to the engine course 1.4.

The racks 1.2.4 of the front axis 1.2 and 1.3.4 of the rear axis 1.3 with pitch and module established as per the gear 1.4.4 of engine 1.4, in other words, according to the variation of the engine model 1.4, at some point the axis racks may undergo changes in format, number of teeth, module, etc.

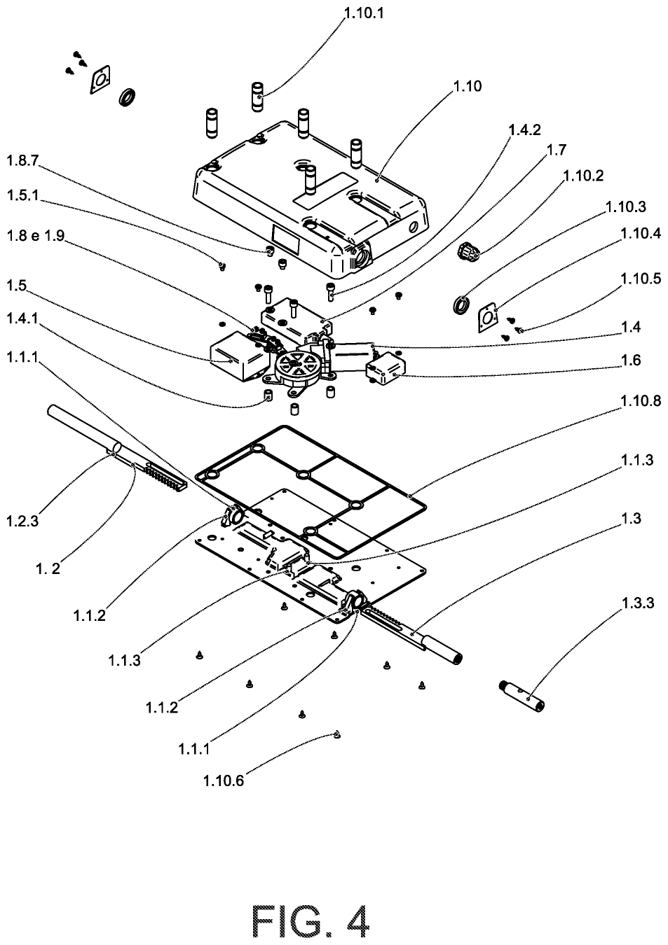

The rear axis 1.3 comprises two ends, one of the ends already welded to the rack 1.3.4 and another loose threaded end 1.3.3, to allow for assembly of the cover 1.10, which may be seen in FIG. 4 with the entire base assembly and after this end 1.3.3 is threaded with chemical fastener, and leaving the entire set of lock 1 assembled and ready for installation.

The dimensions of base 1.1 and axles, both from the lock and its extenders, and may also undergo changes as needed for each project. The projects are comprised as follows: first the location of the lock installation shall be defined in order to acquire the measures of the extender axles according to the total locking course defined by the application; and afterwards, the engine 1.4 and other components (electronic and/or mechanic), which may be placed inside the base 1.1 in order to address all needs established from the start.

This definition is extremely important so that all components are allocated inside the lock 1 to prevent any violation to any internal components and the efficiency of lock 1 is affected.

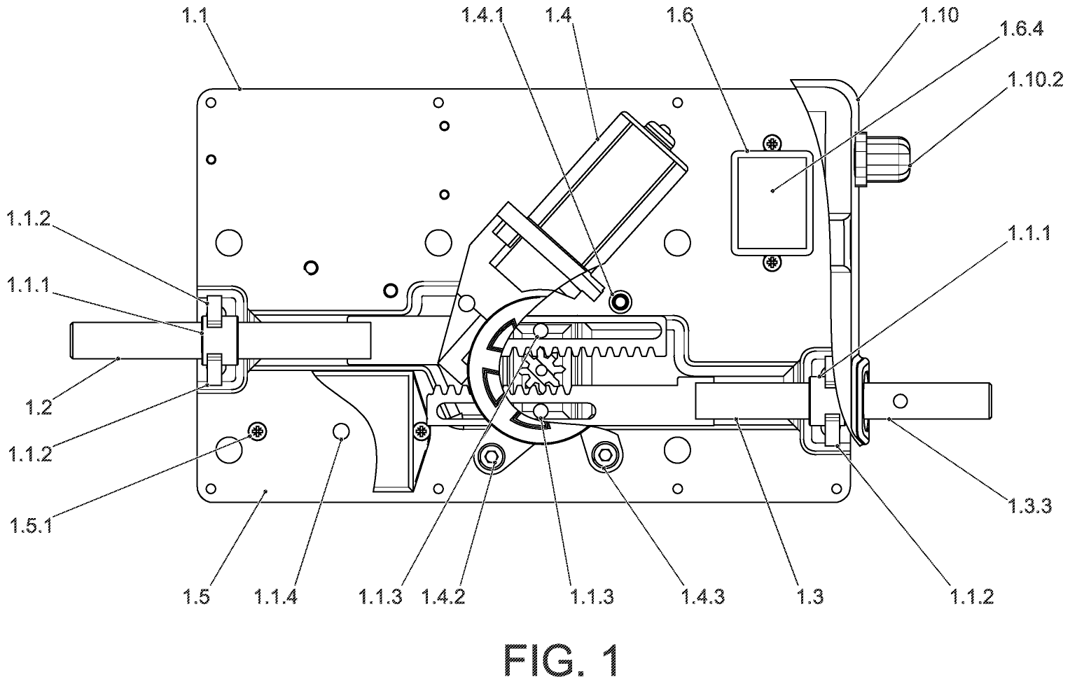

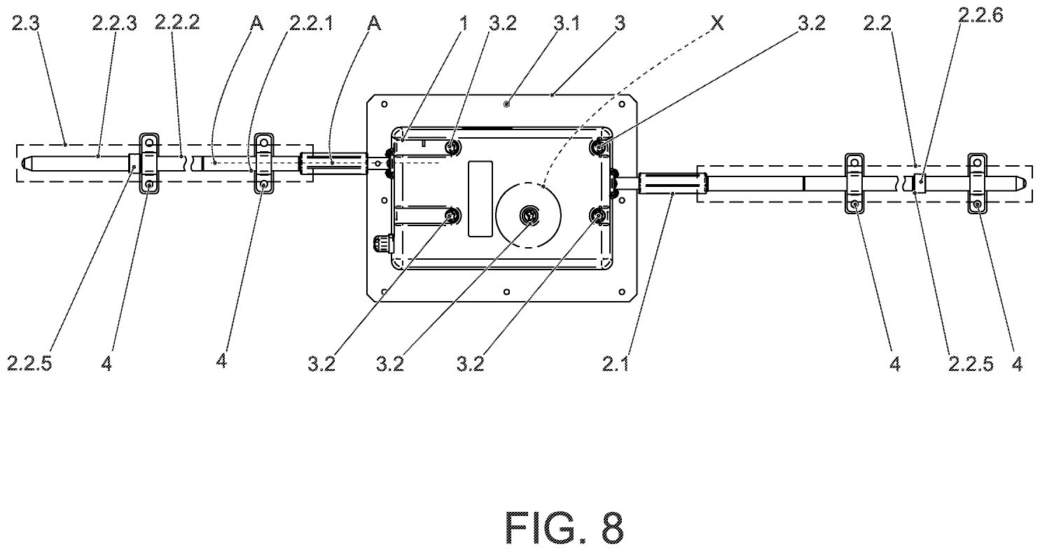

FIG. 1 shows all main components for the basic operation of the lock that is object of this patent application, which are attached to the base 1.1, comprising a bearing 1.1.1 welded to the base 1.1 for the front axis 1.2, the same bearing 1.1.1 welded to the base 1.1 for the rear axis 1.3, and all proper reinforcements 1.1.2 welded around the bearing 1.1.1, two pins 1.1.3 welded to the base 1.1 to prevent the axles from exceeding the course of the engine 1.4 and also to maintain proper guidance for the entire movement. This top 1.1.3 eliminates the need for the use of a rear bearing. Inside the casing of the bearing 1.1.1 where each axis runs through the course limited by the engine 1.4 which, in turn, is fixed to the base 1.1 by three M6 pan head Allen screws 1.4.2 supported by a sleeve 1.4.1 which has the height needed to apply pressure of the engine housing 1.4 in relation to the axles. The M6 pressure washer 1.4.3 with the use of chemical fastener, ensures engine stability and fastening, to prevent vibrations caused by the use of the lock from loosening the attachment and release the motor for its position. The axles are supported on recesses on the base 1.1, thus in conjunction with the engine pressure and alignment of the bearing 1.1.1, maintaining alignment to the holes on the cover 1.10, which may be observed in FIG. 8, leaving the movement stable throughout its linearity. The Bluetooth/Wi-Fi module 1.5 by two M4 Phillips screws 1.5.1 with pressure washer and chemical fastener.

The engine 1.4 performs the locking and unlocking movement, when turning to the clockwise and counterclockwise directions, the motor engagement with the rack of the front 1.2 and rear axles 1.3 transfers the radial engine movement in a linear movement of the axles, performing the locking and unlocking functions.

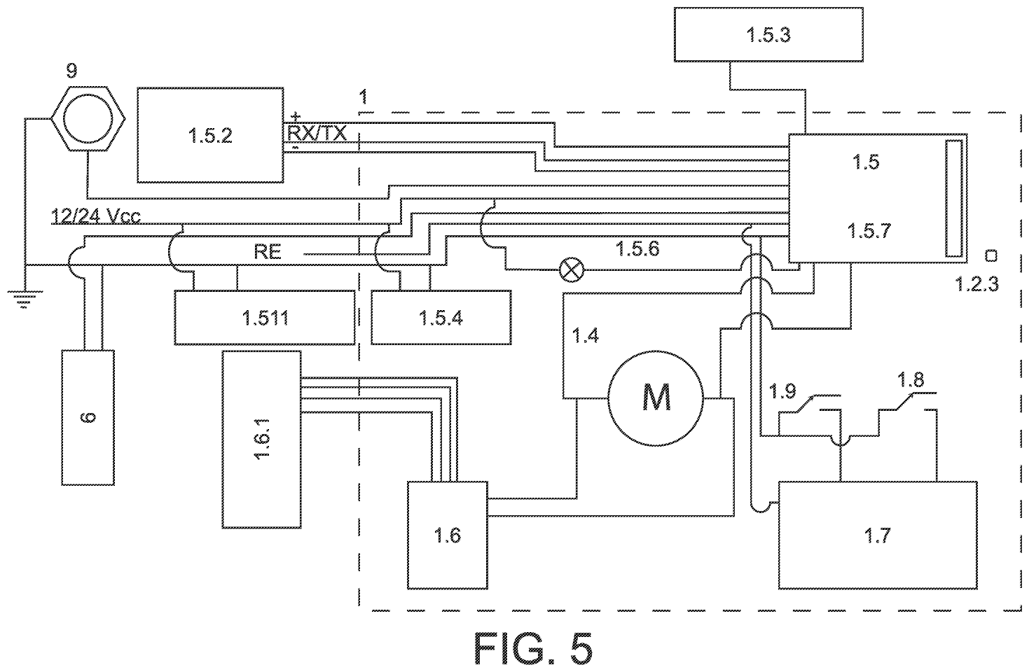

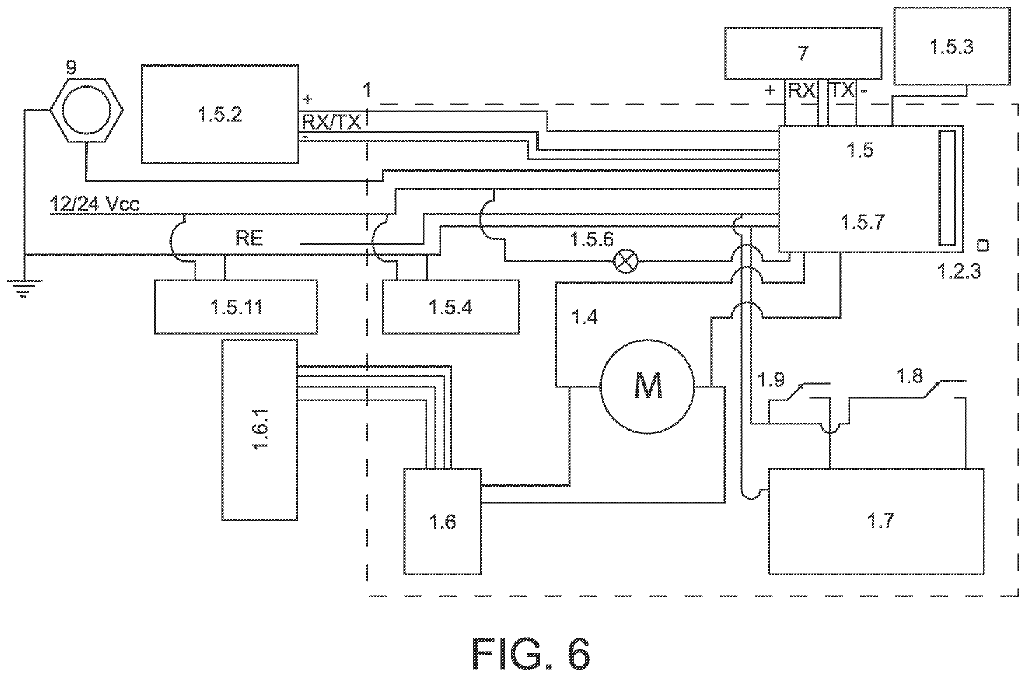

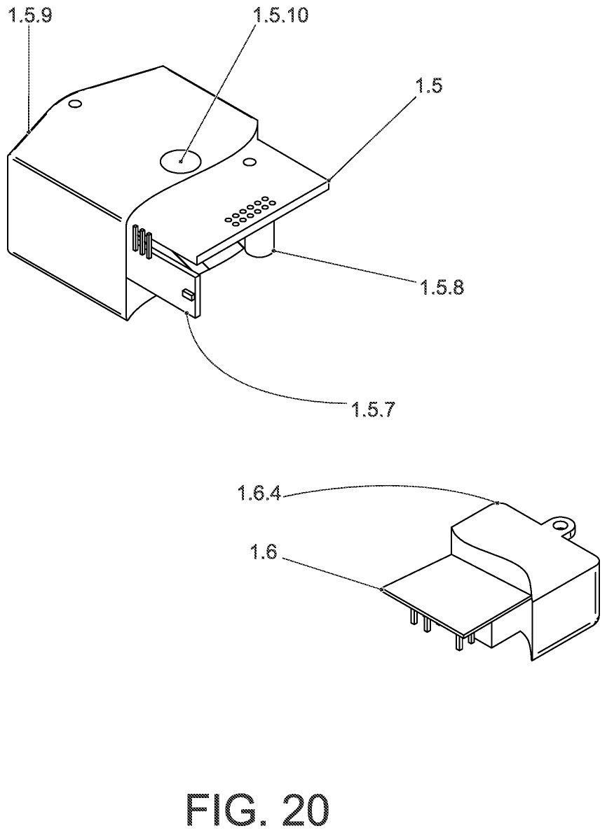

FIG. 5 or 6 show that the feeding of the engine 1.4 is carried out by the Bluetooth/Wi-Fi electronic module 1.5, which is inside a plastic box 1.5.9 (visible in FIG. 20) including a hall sensor 1.5.7 activated by a magnet 1.2.3 fixed to the front axis 1.2, thus the sensor indicates the position of the axles to the Bluetooth/Wi-Fi module 1.5 and drives the engine in the correct movement direction.

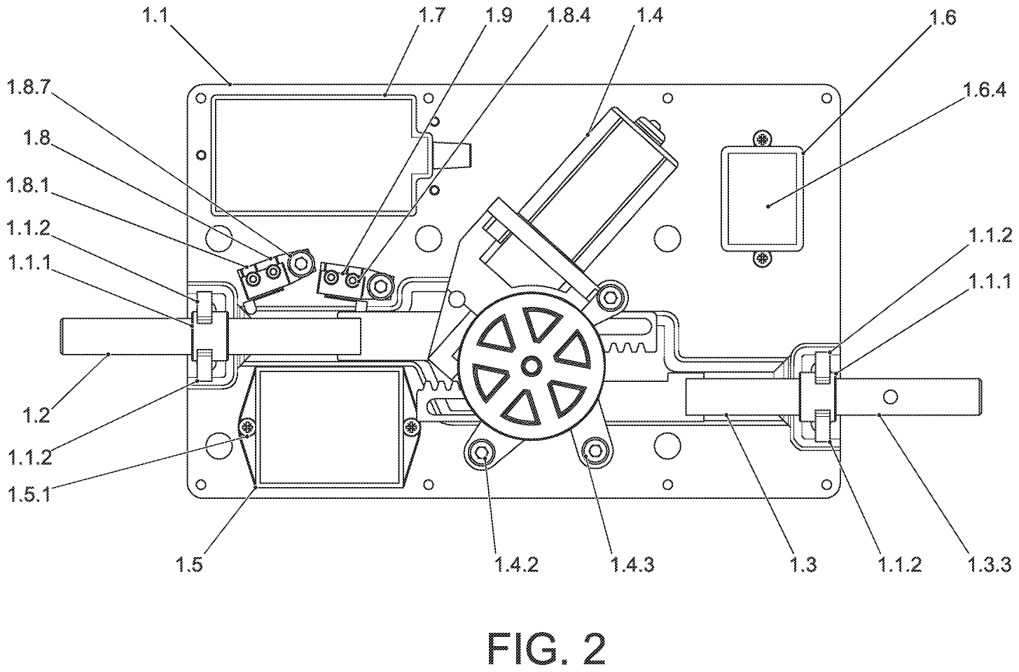

FIG. 2 shows two limit stop switches, one at the front 1.8 and one at the rear 1.9 that are attached to a steel plate 1.8.1 by two M3 flat head Allen screws 1.8.4 and by pressure washer and nut M3. In turn, the plate is fixed to the base 1.1 by a set of M6 Allen screws 1.8.7, M6 pressure washer, the limit stop switches are mounted to the base 1.1 indicating the position of axles for the activation peripherals, when an internal tracker 1.7 is used in addition to the Bluetooth/Wi-Fi module 1.5, with the front 1.8 when driven indicates the “closed” state, in other words, locking state, and the rear limit stop switch 1.9, when activated, indicates the “open” state, in other words, unlocking state. The limit stop switches in their activation points have a pulley format, providing reliability to the actuation of the limit stop switch.

The functioning of these switches may be compared to the use of a button which, when activated, connects two contacts and sends a positive signal to the peripheral.

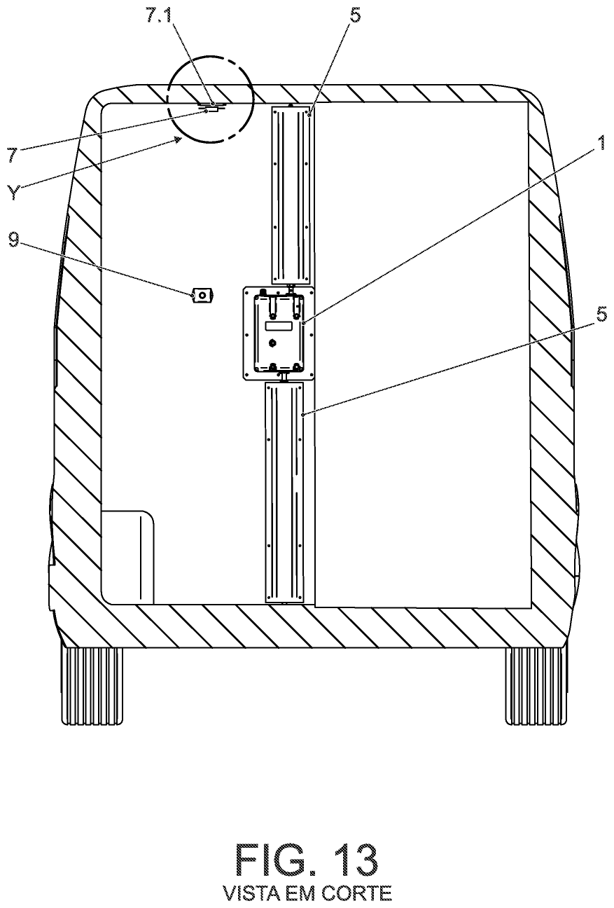

The Bluetooth/Wi-Fi module 1.5 has the objective of coordinating inlets and outlets of the entire lock, with the activation signals as the inlet, either through an internal tracker 1.7, according to patent MU 8601581-8, as may be observed by FIG. 5 or 6, or even activation by an RE external tracker, or activation via the Bluetooth/Wi-Fi module 1.5 itself which requires a counter-password authorization generated by a restricted access center (10.2) developed by the Applicant, seen in FIG. 13.

The signals of hall sensor 1.5.7 indicate the direct position of the axis to the Bluetooth/Wi-Fi module 1.5 and the signal sent via sensor installed to the set of doors, either magnetic 6 (most known and used) or an encrypted sensor 7 which works in pair 7.1 with a tag that only corresponds to it. The sensor signal when received by the Bluetooth/Wi-Fi module 1.5, understands that lock 1 must be closed, so when closing the set of doors to which it is connected, lock 1 closes automatically with the set of doors. The outlet of the Bluetooth/Wi-Fi module 1.5 is the feed of the engine 1.4 when, for each state received inside the Bluetooth/Wi-Fi module 1.5, the outlet polarity is inverted in order to invert the engine movement in both directions.

The model of the Bluetooth/Wi-Fi module 1.5 has a OneWire communication network 1.5.2, in order to address temperature measurement needs in a cold chamber, for example. These temperature sensors 1.5.2 are connected to the Bluetooth/Wi-Fi module 1.5 through three cables. The first positive feed cable for the sensors, the second cable for communication (information sending and receiving), this connection type is known as OneWire, and the third cable for negative feed. This extra communication capacity through the OneWire enables adding up to eight temperature sensors (waterproof) for monitoring the cargo compartment and activating a function inside the Bluetooth/Wi-Fi module 1.5 called “Quebra-Gelo [Icebreaker]”.

This “Quebra-Gelo” function aims at analyzing if a specific routine must be performed, through measurement of the container temperature, since after a certain period, open or closed, lock 1 can become frozen. Such cases occur in cold chamber compartments, where the temperature may reach −40° C. Therefore, the activation of lock 1, either for opening or closure, cannot take place in a single command, then the Bluetooth/Wi-Fi module 1.5 performs a routine, sending various shorter commands, until the status is modified (the lock reaches the course end on the hall sensor 1.5, or limit stop switch when used in extra inlets).

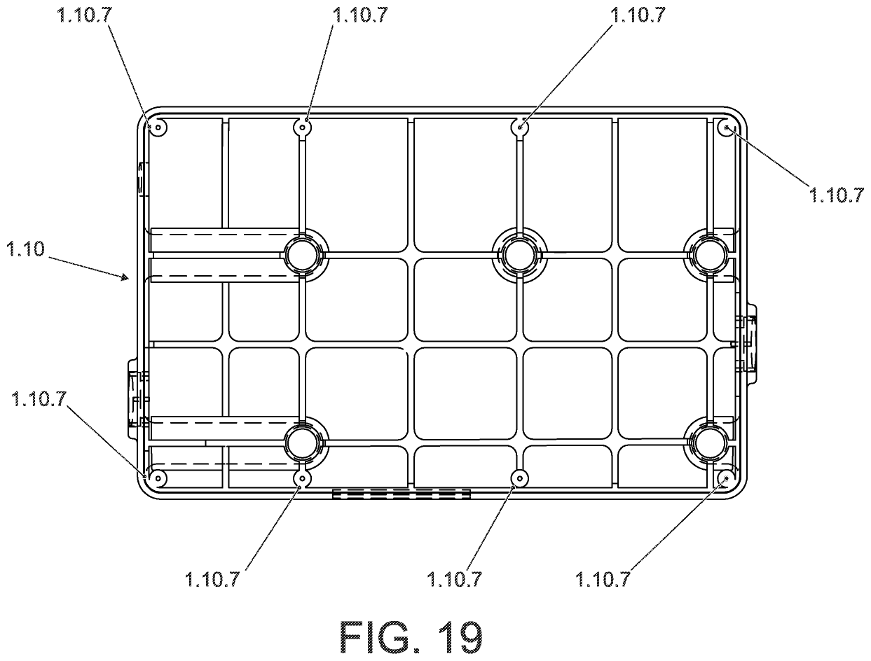

Another one of the functionalities of the Bluetooth/Wi-Fi module 1.5 that may be seen in FIG. 19 is the capacity for connections to other peripherals, through use of wi-fi technology and discarding the use of any wires for integration and control of other peripherals that bare installed and made use of the same module, for example, in truck applications, fifth wheel lock 11, another lock 1 installed to the side door of the cargo compartment, a wireless blocker 12, a wi-fi video camera 13 to record the opening and closing moment, such as in various other peripherals that may be integrated, as per operation planning and client needs.

Another important sensor included in this Bluetooth/Wi-Fi module 1.5 is the three-axis accelerometer 1.5.8 which allows identification of the position of lock 1 at the time of installation, therefore, if it undergoes any movement on the axles outside a pre-established tolerance, such as releasing the lock from the original position to prevent it from performing the locking correctly, this will be identified in this module and an alarm signal will be sent to the tracker (internal or external) or application for use 10 and the responsible personnel will be noticed in order to reposition lock 1 at the original location, thus avoiding frauds and undue incidents. These needs shall depend on each specific client project. In conjunction with the accelerometer 1.5.8, another sensor is already assembled to the Bluetooth/Wi-Fi module 1.5, in which a luminosity sensor 1.5.10, more commonly known as LDR, is able to identify through the light. This LDR sensor 1.5.10 corresponds with a hole 1.1.4 at the base 1.1 for light passage. Base 1.1 receives a resin layer, or any other kind of polymer, transparent to maintain sealing as a hole and also allow for light collection at the sensor point, to identify if lock 1 was removed from its position or not.

In order to prevent any violation of this sensor LDR 1.5.10, the set of the accelerometer 1.5.8 sensor and the LDR sensor 1.5.10 prevents non-authorized people from moving lock 1 from its position such as originally installed. Then an alarm is sent to the tracker (internal or external) and the Webservice center 10.2.

The Bluetooth/Wi-Fi module 1.5 also includes extra inputs and outputs to address more applications. An external physical keypad 1.5.3 may be added for combined activation with the other possible methods. Another possible addition are said limit stop switches for, in conjunction with the hall sensor 1.5.7, opening and closing the lock 1. An alarm siren 1.5.6 may also be added to the Bluetooth/Wi-Fi module 1.5 outputs to signal the user/driver, through sound alarms, safety warnings pre-set on the webservice 10.2.

Another optional feature for the lock 1 is a backup battery 1.5.4, as seen in drawings 5 or 6, for opening in case of power outage, for facilities where the lock 1 is fed through a conventional power network (127/220 Vca), or in case of battery depletion of the installed vehicle. This backup battery 1.5.4 may also be equipped with a solar charger 1.5.11 for better energy use and a lower consumption in the main power source.

FIG. 5 shows that two sets of electric cables come out of lock 1, and if used with additional sensors and/or actuators 1.5.1 another set of cables is added. A set of four cables for a safety opening switch 1.6.1 and another with four cables (five in case of emergency button usage) for the use of a magnetic sensor 6, or in FIG. 6 where it is possible to see two cable sets, and if used with more sensors and/or actuators 1.5.1 another cable set is added. A set of four cables for the emergency opening switch 1.6.1 and another set of seven cables (eight when the emergency button is used) with the use of the encrypted sensor 7. Said cables are assembled near an automotive-type connector that ensures the connection remains up at all times, unless disconnection is forced.

From the four cables of the first set seen when the magnetic sensor 6 is used, the first cable is a positive connection of lock 1, where it should be plugged to a 12/24 Vcc power source (bi-volt), the second cable is the negative connection of lock 1 and must be grounded, or connected to the negative side of the power source, the third cable is the pulse of the sensor 6, which indicates if the set of doors where it is installed is open or closed, and the fourth cable is the inlet of an external tracker RE, or internal that is placed inside the lock assembly, as per MU 8601581-8. The second set of cables is from an emergency connection of a second electronic module 1.6 (which is also placed inside a plastic box 1.6.4) which is actuated when in contact with a special safety switch 1.6.1, to be used only in case any other actuation method does not work. Its operation is through RS485 technology, totally disconnected from the previous circuit and no active feeding by the same network of the Bluetooth/Wi-Fi module 1.5. This module RS485 is off all the time and is only activated (external feeding) when the external safety switch 1.6.1 is connected to a plug available in the connections input of lock 1. With this safety switch, the lock may be opened independently of the tracker (internal or external), or the Bluetooth/Wi-Fi module 1.5 This safety switch 1.6.1 cannot be in possession of the operator/driver/user. It must be kept by the clients' security department, because its use is restricted and must only be used in contingency, in other words, only when opening methods using trackers (internal or external) and opening through the Bluetooth/Wi-Fi module 1.5 are not possible (in case of failure). This special safety switch 1.6.1, before use, must first be recorded through a recording module 1.6.2 receiving information regarding user, place of use, date and time as a use interval, from the webservice platform of the Applicant 10.2. This information received from the recording module are saved in the safety switch through a cable, and afterwards the switch is ready for opening.

It should be noted that the Bluetooth/Wi-Fi module 1.5 works in combination with the application for use 10 when deployed in projects where the lock is used by mobile users or by an interconnected Wi-Fi network for opening by a remote team.

The set of seven cables derived from the lock if an encrypted sensor 7 is used, two connectors are considered, one being a three-way connector for feeding the lock, and an external RE tracker input. And the other exclusive sensor connector, with the first cable for positive feed of the sensor, the second cable for negative feed, the third being a communication sending wire and the fourth cable being a communication receiving wire. In addition, it has the same set of cables previously presented for opening in case there is no activation.

Optionally, a button for emergency opening 9 may be installed, along with the entire set of the lock 1, so in potentially deadly incidents, in other words, the user/driver being trapped inside the cargo box, a container or a vault room, it is still possible to open from the inside.

After all components are assembled on the base 1.1, the connection cables of the lock 1 are passed through the hole on the cover 1.10, where a PG-11 standard cable gland 1.10.2 helps in sealing the lock, on the cover 1.10 there are five bushings 1.10.1 for better guidance of the screw when using the fastening of the lock 1 onto installation surfaces. The cover 1.10 is attached to the base 1.1 by eight self-tapping 3.5 Phillips screws 1.10.6, said components may be seen in FIG. 4.

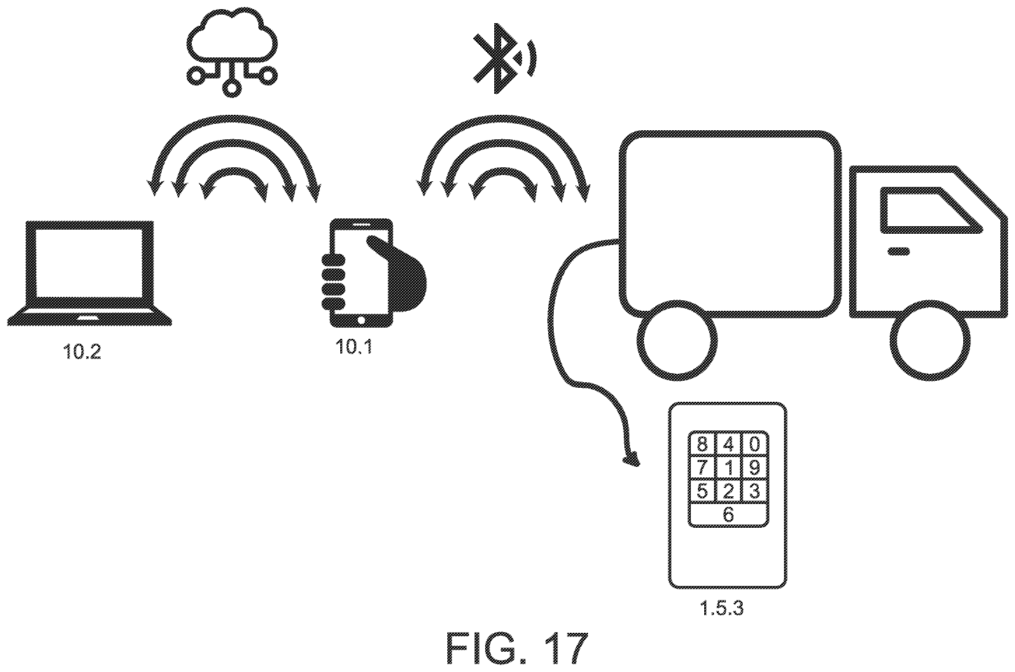

As the cover 1.10 is made of injected engineering plastic, it has fastening towers 1.10.7 prepared for said screws, as may be seen in FIG. 17.

Also attached to the cover 1.10 is a retainer 1.10.3 for each axis, in order to maximize the sealing of the outer lock, and prevent any dust or fluid from affecting the lock function. These retainers are fitted in a special slot designed on the cover 1.10 and are fastened by pressure caused by a plate 1.10.4 shaped according to the slot and fixed with three self-tapping 3.5 Phillips screws 1.10.5 directly to the cover 1.10. Between the assembly of the cover 1.10 and the base 1.1, with all components already mounted, a mantle 1.10.8 is placed, which may be seen in FIG. 4 of a sealing material so that any point that may end up with enough seepage space is sealed by this mantle 1.10.8, granting additional sealing points.

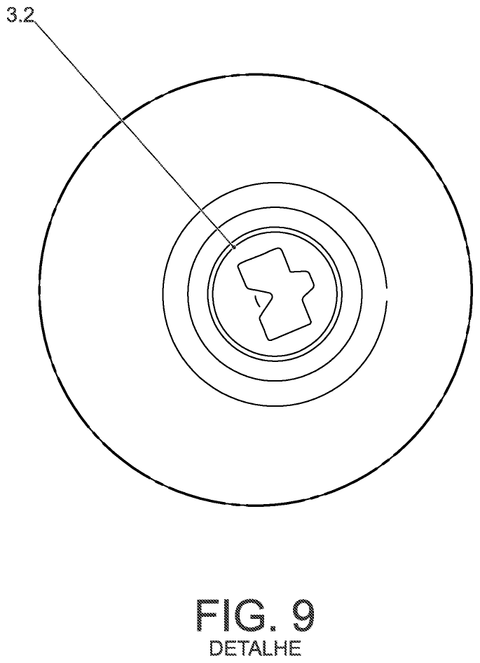

FIG. 8 shows the installation of the lock with the rest of the components. In each end of the lock axles 1 a nut is installed, called yoke nut 2.1, which is fixed by a M8 partial thread hex head screw 2.1.1, and this screw may be seen in the sectional FIG. 9 passing through the internal part. This nut remains loose until the connection with the rest of the extension axis.

The extension axis (lower 2.2 or upper 2.3) comprises three pieces. The first piece called threaded axis tip 2.2.1, the second piece called intermediate axis tube 2.2.2 and the last piece called chamfer axis end 2.2.3.

The design of these items was such as to allow for one-time installation of external lock peripherals, so that the lock 1 has a portability differential in relation to patent MU 8601581-8.

Therefore, the installation of components outside the lock 1 is done as follows: two sets of cables are laid, one set for feeding and another for activation of the safety switch, or more depending on the application. Afterwards, the structure that receives the lock must include a lock reinforcement plate 3 placed at an equivalent height to the locking point, fixed by rivets 3.1 around the plate. Then the lock 1 is fastened on this reinforcement plate 3 by five M8 customized safety screws 3.2 and a pressure washer. At the end of the lock 1 the yoke nuts 2.1 are fixed with their respective screws and then the extension axles are threaded.

In order to assemble the extension axis on lock 1, the threaded axis end 2.2.1 must be threaded to the yoke nut 2.1, then the intermediate axis tube 2.2.2 measurement is taken regarding the activation course, subtracting the measure of the chamfer axis end 2.2.3. With the intermediate axis tube 2.2.2 in the correct measure, a hole is drilled at the base of the tube near the axis and fixed using the tube on the threaded axis end 2.2.1 by a M8 hex head screw 2.2.4 with pressure nut and washer. The process is repeated for fixing the chamfer axis end 2.2.3 to the other end of the intermediate axis tube 2.2.2. This process is done both for the lower extension axis 2.2 and the upper extension axis 2.2 For safety reasons, after all intermediate tubes are fixed in both axis ends using all due screws, welding the nut and screws is recommended, thus avoiding undue disconnection. In order to maintain linearity and free movement of the axles, bearings 4 are placed throughout the length of the axles, ensuring the correct movement without forcing the system of the lock 1.

FIG. 9 shows a better picture of how the connection between the extension axles and the axles of the lock 1 is assembled.

Near each axis end, a locking ring 2.2.5 is attached by a M8 hex head screw 2.2.6 before the bearings 4 closest to the edges, to prevent the axis from slipping through the bearings and out of the alignment when lock 1 is disengaged.

With external components and lock 1 already fastened, the lock 1 may be exchanged or only removed simply or quickly. When unscrewing the yoke nut 2.1 the extension axles remain free, and when disconnecting the electric connectors of lock 1, the five screws that fasten the lock to the reinforcement plate 3 may be removed and the lock 1 may be removed, or replaced. This ensures increased agility and portability for application when the use of the lock 1 was a pre-set period, in other words, the service provider for trucks or container usage, its usage will be restricted to the period where the cargo is being transported to a certain client which usually will be the lock owner, object of this Invention patent application. The client may install the lock in locations (truck cargo boxes/containers) considered necessary, for a much more rational and smart use, reducing operational costs when compared to solutions currently used and known in the state of the art.

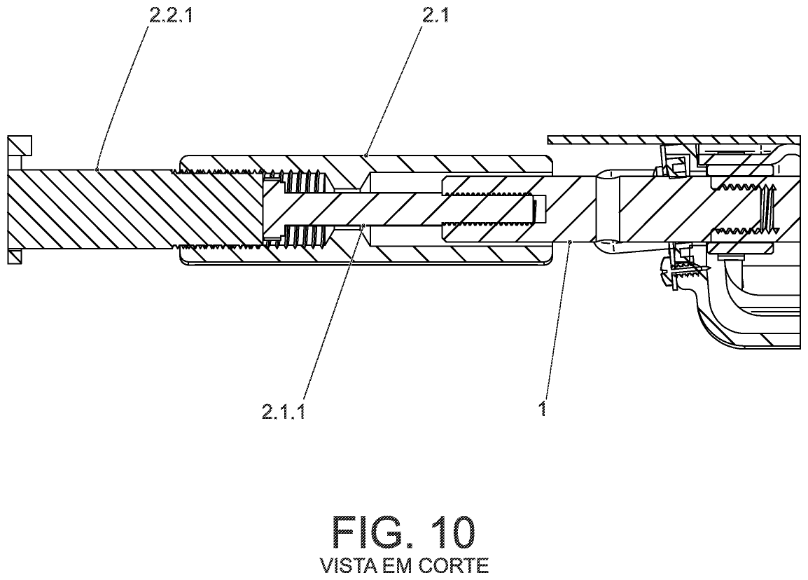

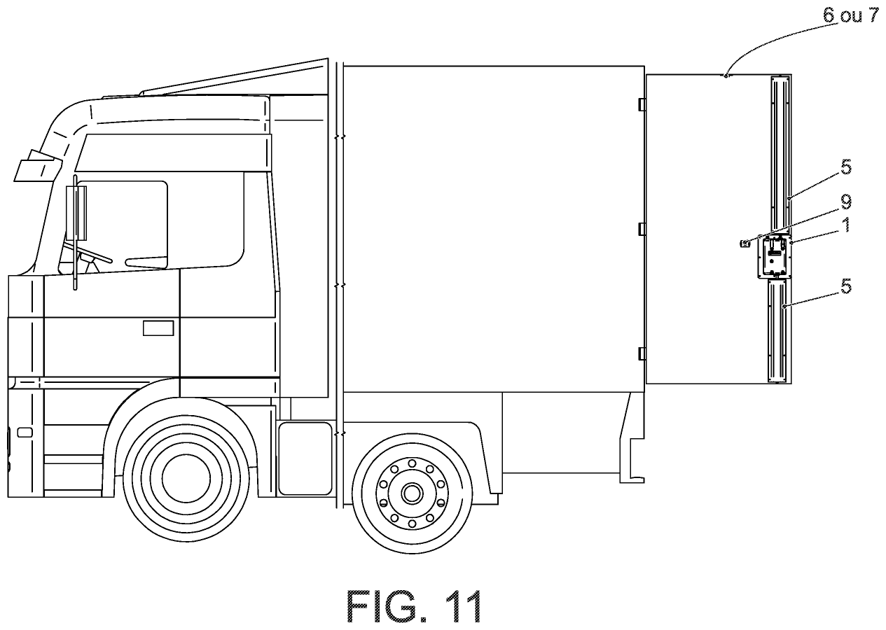

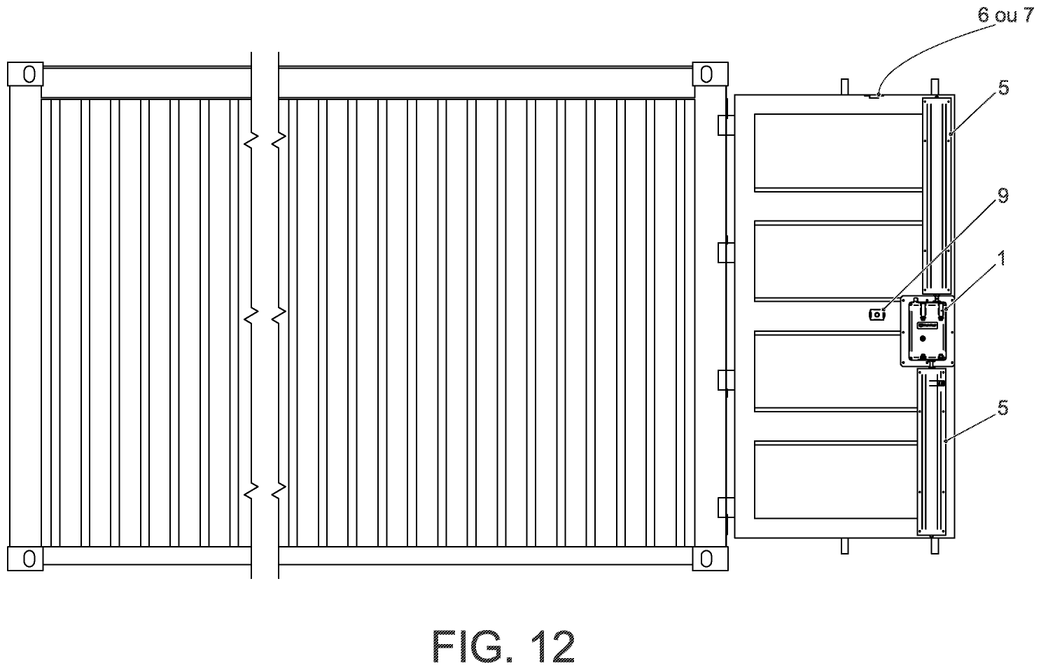

In order to protect this system, protection gutters 5 must be installed, ensuring no other cargo or other elements may damage the extension axles, as may be seen in FIG. 10 or 11 or even FIG. 12.

The locks and their accessories may be manufactured in several materials and finishes, such as standard 1020/1045 zinc-plated, bichromate or electrostatic painted steel. They may be manufactured in 304/316 stainless steel when needed for cooled locations, such as cargo box trucks or cold chamber trucks, when this lock type is needed, as it includes internal cooling and incidents may occur, therefore stainless steel is needed to prevent the locks from rusting.

A cementing or tempering layer may be applied to the axles, in order to generate additional difficulties in case of a robbery incident, making cutting more difficult using a saw or similar alternative, due to the fact that the external layer will be much harder than the internal layer, preventing any cutting by this kind of tool.

Hence, this lock addresses issues and limitations normally seen in more standard solutions already known in the state of the art.

Within the basic construction described above, the lock, object of this Invention patent application, may show modifications related to materials, dimensions, construction details and/or configurations without deviating from the scope of the requested patent protection.

### DESCRIPTION OF OPERATION

The lock, object of this Invention patent application, was developed for use in access control restriction under authorization conditions.

An application example is in vehicles, where a set is installed on the doors for cargo access control. FIGS. 10, 11, 12 show this application example on a truck, a container and a van.

In this example, in order to disengage the lock, the user must employ a previously chosen and installed method for opening, for example, activation by tracker, or use of the Bluetooth/Wi-Fi module 1.5 developed by the Applicant, or another opening device. This way, the Bluetooth/Wi-Fi module 1.5 will receive the opening command and unlock the system.

In case of any power or electronic failure, the user must then employ a special safety switch 1.6.1, which will be connected to a specific point. This makes the connection with the contingency RS485 electronics 1.6, allowing the lock 1 to be opened and unlocking the system. In order for the safety opening switch 1.6.1 to work, safety information must be recorded in it, such as date and place and usage time, location and allocated user through a recording module 1.6.2 which is connected to the key via a cable.

For closing the set of doors, or door, as soon as the sensor detects closing (either one), the system acknowledges, in other words, the door must be closed for the sensor to work, the Bluetooth/Wi-Fi module 1.5 shall lock the system by lock 1. When the closing sensor fails, the contingency closing function is used, generating a password and a counter-password on the webservice 10.2 to close the lock 1.

If not closed, the technical assistance team must be called, to perform proper diagnostics and repairs to the lock assembly 1 that is object of this Invention patent application.

The Bluetooth/Wi-Fi module 1.5 was developed with a stand-alone and safe opening method for use in combination with the application for use 10. The application for use 10 works in two phases; in the first, a password is generated by a user in the same location as the assembly, since when accessing through the application 10.1, the mobile device connects via Bluetooth with the assembly and a password is generated by the application, which must be informed on the second phase.

In the second phase of the process the user must inform this password to a security center, which will validate this password with the geographical position of the user that requests the opening.

The user of the smartphone application 10.1 (for Android 4.0 operating system or higher) must insert username and password to access the device panel. With the device panel now open, the user then selects as desired, connects and opens. The device screen shows the “Door Closed” and “Lock Engaged” statuses, conforming the physical state of the assembly. When the password button is pressed, the application 10.1 shows a password with 24 alphanumerical characters, including: the requesting user, mobile phone IMEI number, date and time, and MAC address of the Bluetooth, latitude and longitude of the geographical position, in other words, a series of validations for ensuring the accurate information of the requesting person, where it is being requested to and which lock 1 to open. The user then informs the password to the security center.

The center validates the password sent by the application user, the center operator must insert the password in the webservice counter-password panel 10.2 (available for any operating system with Internet features), selecting the requesting user and the password informed. The web application10.2 then shows the password position and validation, and the assistant confirms the position found by the app, afterwards informing the counter-password for opening the assembly.

The user in the opening location must then insert the counter-password and press the button on the application 10.1 for opening, therefore the statuses on the panel must switch to “Lock Disengaged”, and at the time the door is opened, switch to “Door Open”, remaining as such until it is closed again.

This opening method is able to encompass all points, as it is not affected by blind spots (areas where GRPS signals are weak or nonexistent).

Another opening alternative through the application for use 10 developed by the Applicant consists in registering opening points on the cloud-hosted webservice 10.2, in which all points where the app (10.1) must perform the opening automatically are already defined (enabling the open button in authorized locations), not requiring the generation of passwords and counter-passwords to open, nor the intervention of a center for that purpose.

These points may be recorded manually in the webservice 10.2 and directly to the platform, uploading an electronic spreadsheet format file or by API, in which these points may be gathered directly from a client ERP software or similar, which presets all opening points (delivery locations/client addresses) allocated per vehicle (plate) and sent for allocation of this information to the smartphone app 10.1. As soon as the information is allocated on our webservice platform 10.2, the user already knows all delivery points (opening points) assigned for that vehicle equipped with the lock that is object of this Invention patent application when logging in to the smartphone application 10.1.

1. “SAFETY LOCK WITH DOUBLE CLOSURE AND APPLICATION FOR USE”, the safety lock (1) including a base (1.1) which is closed by a cover (1.10) and on which an engine (1.4) is assembled, with a gear (1.4.4) that is engaged to the rack (1.2.4) of the front axis (1.2); the engine (1.4) is attached to the base (1.1) by an M6 pan head Allen screw (1.4.2) supported by a bushing (1.4.1) with the height needed to apply pressure from the engine housing (1.4) to the axles; M6 pressure washers are also used (1.4.3) with the chemical fastener; the lock (1) is combined with an alarm siren (1.5.6) and equipped with a backup battery (1.5.4) which may be coupled to an external solar charger, wherein the lock (1) includes the rear axis (1.3); the front axis (1.2) and the rear axis (1.3) sliding inside the respective bearings (1.1.1) which are supported on base recesses (1.1); the bearings (1.1.1) are welded to respective support reinforcements (1.1.2); the lock (1) includes pins (1.1.3) welded to the base (1.1) of the lock (1); the pins (1.1.2) and (1.1.3) include racks (1.2.4) and (1.3.4) on the respective ends, in addition to respective oblong openings (1.2.5) and (1.3.5), such oblong openings occurring individually on each pin (1.1.3); the gear (1.4.4) is simultaneously engaged to the racks (1.2.4) and (1.3.4); the front (1.2) and rear axles (1.3) define a double closure applied by the lock (1); the lock (1) includes two limit stop switches, one at the front (1.8) and one at the rear (1.9), which are attached to a steel plate (1.8.1) by two M3 flat head Allen screws (1.8.4) and a M3 pressure nut and washer, whereas the steel plate (1.8.1) is attached to the base (1.1) by a set of M6 Allen screws (1.8.7) and M6 pressure washer; the limit stop switches (1.8) and (1.9) are mounted to the base (1.1), indicating the position of axles to the activation peripherals, when an internal tracker (1.7) is used, in addition to the Bluetooth/Wi-Fi module (1.5) internally mounted to the lock (1) and attached by two M4 Phillips screws (1.5.1) with pressure washer and chemical fastener; engine feeding (1.4) is carried out by the Bluetooth/Wi-Fi electronic module (1.5) inside a plastic box (1.5.9) with a hall sensor (1.5.7) activated by a magnet (1.2.3) attached to the front axis (1.2), hence, the sensor indicates which is the axis position for the Bluetooth/Wi-Fi module (1.5) and drives the engine in the correct movement direction; the lock (1) comprises a lower (2.2) or upper (2.3) extension axis, which is composed by three parts, in other words: the tip of the thread axis (2.2.1), the intermediate axis pipe (2.2.2) and the tip of the chamfer axis (2.2.3), also including a yoke nut (2.1), and each axis end receives a locking ring (2.2.5) by a M8 hex head screw (2.2.6) before the bearings (4) closer to the edges; each yoke nut (2.1) is fixed by a hex head screw with partial M8 thread (2.1.1); the front switch (1.8), when activated, indicates the “closed” state, in other words, locked state, and the rear limit stop switch (1.9) when activated, indicates the “open” state, in other words, unlocked state; the lock (1) includes a three-axis accelerometer (1.5.8), real-time temperature measurement sensors (1.5.2), built-in safety switch (1.6.1) for situations of application or main hardware failure; the lock (1) features integration with use application (10), including safety validations; the lock (1) assembly includes protection gutters (5), which protect the extension axles; the Bluetooth/Wi-Fi module (1.5) includes a lighting sensor (1.5.10) “LDR”, which operates through light identification, said sensor being aligned with a hole (1.1.4) at the base (1.1) for passage of light; a second electronic module (1.6), which is also placed inside a plastic box (1.6.4), is activated when in contact with a special safety switch (1.6.1), which will be used only if no other activation method works, and its function takes place through a RS485 technology; in order to be used, the special safety switch (1.6.1) must first be recorded through a recording module (1.6.2), which receives user information, use location, date and time as intervals for use thereof, from the webservice platform (10.2); said information received in the recording module are recorded in the safety switch through a cable, and afterwards the switch is ready to be opened.

2. “SAFETY LOCK WITH DOUBLE CLOSURE AND APPLICATION FOR USE”, according to claim 1, wherein the internal module comprises the Bluetooth, Wi-Fi, GPS, Chip LORAWAn and SigFOX technologies, RF (Radio Frequency) communication module and Zigbee communication module with own network that allows integration with other wireless peripherals.

3. “SAFETY LOCK WITH DOUBLE CLOSURE AND APPLICATION FOR USE”, according to claim 1, wherein it includes a hardware having integration with an encrypted door sensor (7) with a unique ID, which operates in combination with a tag (7.1).

4. “SAFETY LOCK WITH DOUBLE CLOSURE AND APPLICATION FOR USE”, according to claim 1, wherein it includes safety screws (3.2) used for mounting the lock (1) on a reinforcement plate (3), said safety screws (3.2) may be operated only with a special tool (3.2.1) equipped with a coupling mouthpiece (3.2.1.1) with internal protrusion (3.2.1.2) compatible with the cavity (3.3) provided on the head (3.4) of the screw (3.2); the safety screws (3.2) and the special tool (3.2.1) allow for installation and removal of the lock (1).

5. “SAFETY LOCK WITH DOUBLE CLOSURE AND APPLICATION FOR USE”, according to claim 1, wherein the lock (1) is integrated to peripherals including: wireless vehicle blockers (12), numerical keyboards (1.5.3), wi-fi cameras (13) for event recording, fifth wheel lock (11).

6. “SAFETY LOCK WITH DOUBLE CLOSURE AND APPLICATION FOR USE”, according to claim 1, wherein it includes an emergency button (9) for emergency opening in combination with the entire lock assembly (1), magnetic sensor (6), solar charger (1.5.11) and external tracker.

7. “SAFETY LOCK WITH DOUBLE CLOSURE AND APPLICATION FOR USE”, according to claim 1, wherein the Bluetooth/Wi-Fi module (1.5) controls all actions of the lock (1) and other sensors, the main ones being lock opening and closure through a smartphone with encrypted commands, open and closed door status, locked and unlocked pin status, door violation status, pin not reached the end of its course status, monitoring of engine running current (1.4) for detection of possible wear and allocation for preventive maintenance, internal box temperature status through the OneWire network, accelerometer (1.5.8) for identification of installation position and possible breach, guarantee of opening only in valid prerecorded points, predefined door opening time control as safety rule with alarm generation when it is breached, showing as a warning: “Door opening time exceeded”, encrypted door opening and closing sensor (7) with factory-made registration and setup, control of openings and vehicles per prerecorded user in the cloud-hosted webservice (10.2); the activation of the Bluetooth/Wi-Fi module 1.5 requires a counter-password authorization generated by the webservice (10.2).

8. “SAFETY LOCK WITH DOUBLE CLOSURE AND APPLICATION FOR USE”, according to claim 1, wherein the Bluetooth/Wi-Fi module (1.5) has a OneWire communication in order to address measurement needs in a cold chamber box; temperature sensors (1.5.2) are connected to the Bluetooth/Wi-Fi module (1.5) through three cables, where the first cable is the positive feed to the sensors; the second cable for communication, information sending and receiving; and the third cable for negative feed; the extra communication capacity through the OneWire network, thus possibly resulting in the addition of eight temperature sensors for monitoring of the cargo compartment and activation of a function inside the Bluetooth/Wi-Fi module (1.5) called “Quebra-Gelo”.

9. “SAFETY LOCK WITH DOUBLE CLOSURE AND APPLICATION FOR USE”, according to claim 8, wherein the “Quebra-Gelo” function analyzes, through temperature measurement of the cargo compartment, if a specific routine running to avoid lock (1) freezing is required.

10. “SAFETY LOCK WITH DOUBLE CLOSURE AND APPLICATION FOR USE”, according to claim 1, wherein the Bluetooth/Wi-Fi module (1.5) operates in conjunction with the application for use (10) in two phases, where the first one generates a password per user through the application (10.1), so that the mobile device connects with the lock (1) via Bluetooth, and a password is generated through the application, which must be informed in the second phase; in the second phase, the user must inform this password to a safety center, where said password is validated combined with the geographical position of the user that is requesting the opening; the smartphone app user (10.1) must insert username and password to access the device panel; when the device panel opens, one must select as desired and connect when opening; when the device screen opens, the “Closed Door” and “Closed Lock” statuses are shown, conforming the physical state of the assembly; by pressing the password button on the app (10.1), a 24-character alphanumeric password shows up that includes: the requesting user, mobile device IMEI, date and time, and Bluetooth MAC Address, latitude and longitude of geographical position, defining a series of validations; for the center to validate the password generated by the app user, the center assistant must insert the password to the counter-password panel in the webservice (10.2), selecting the request user and the password informed; the web application (10.2) then shows the password position and validation, and the assistant must confirm the position found by the app and then inform the counter-password to open the assembly; the user at the opening location must then insert the counter-password and press the button on the application (10.1) to open, and the statuses on the panel should change to “Lock Open”, changing to “Door Open” when the door opens, and remaining as such until they are closed.

11. “SAFETY LOCK WITH DOUBLE CLOSURE AND APPLICATION FOR USE”, according to claim 10, wherein another opening alternative through the application for use (10) consists in registering opening points on the cloud-hosted webservice (10.2), in which all points where the app (10.1) must perform the opening automatically by enabling the open button in authorized locations, not requiring the generation of passwords and counter-passwords to open, nor the intervention of a center for that purpose.
